(19) United States
(12) Patent Application Publication
(10) Pub. No.: US 2010/0041785 A1
(43) Pub. Date: Feb. 18, 2010

(54) PHOTOSENSITIVE RESIN COMPOSITION AND PHOTOSENSITIVE ELEMENT USING THE SAME

(75) Inventors: Takeshi Ohashi, Hitachi-shi (JP); Tetsuya Yoshida, Hitachi-shi (JP); Satoshi Ootomo, Hitachi-shi (JP)

Correspondence Address: GRIFFIN & SZIPL, PC, SUITE PH-1, 2300 NINTH STREET, SOUTH, ARLINGTON, VA, 22204, US

(73) Assignee: HITACHI CHEMICAL COMPANY, LTD., Tokyo (JP)

(21) Appl. No.: 12/089,504

(22) PCT Filed: Aug. 8, 2006
(86) PCT No.: PCT/JP2006/315659

§ 371 Date: Sep. 21, 2009

(30) Foreign Application Priority Data
Oct. 7, 2005 (JP) 2005-294882
Mar. 8, 2006 (JP) 2006-063173

(51) Int. Cl. C08F 2/46

(52) U.S. Cl. 522/78

(57) ABSTRACT

The photosensitive resin composition of the invention comprises (A) a carboxyl group-containing binder polymer, (B) a photopolymerizing compound, (C) a photopolymerization initiator and (D) a dicyandiamide and/or its derivative, wherein the (B) photopolymerizing compound contains (B1) a compound with a weight-average molecular weight of 3500-100000 and with an urethane bond and an ethylenic unsaturated group in the molecule.

### TECHNICAL FIELD

The present invention relates to a photosensitive resin composition and to a photosensitive element employing it.

### BACKGROUND ART

Conventional manufacturing of printed circuit boards employs photosensitive resin composition liquids or films. For example, photosensitive resin compositions are used in steps for forming circuits on boards by etching of copper foils on copper clad laminates, as resists to protect the copper foil sections that will serve as circuits. In the steps following circuit formation, photosensitive resin compositions are used as resists to restrict the soldering locations and protect the circuits. Since manufacturing of printed circuit boards involves chemical treatment and plating treatment, the resist must exhibit properties such as chemical resistance and plating resistance.

Photosensitive resin compositions having the properties required for resists even after photocuring have been proposed in the prior art. For example, Patent document 1 discloses a photosensitive resin composition that when photocured exhibits excellent mechanical strength, adhesiveness, chemical resistance, flexibility and plating resistance.

Printed circuit boards also include boards known as “flexible printed circuit boards” (hereinafter referred to as “FPC”). Such boards are flexible enough to be folded and integrated into miniature devices such as cameras and cellular phones. FPCs also require resists to restrict soldering locations and protect their circuits. These are commonly known as cover lays or cover coats.

[Patent document 1] Japanese Unexamined Patent Publication HEI No. 8-297368

### DISCLOSURE OF THE INVENTION

### Problem to be Solved by the Invention

The photosensitive resin compositions used to form FPC resists have a special requirement for excellent flexibility after photocuring, unlike those used for formation of ordinary printed circuit board resists. The photocured photosensitive resin composition described in Patent document 1 is flexible but is in need of further improvement for even higher flexibility. Its plating resistance is also not entirely satisfactory for use in FPCs. It is therefore an object of the present invention to provide a photosensitive resin composition that can achieve high levels of flexibility, chemical resistance and plating resistance after photocuring. Another object of the invention is to provide a photosensitive element employing the composition.

### Means for Solving the Problem

In order to achieve the objects stated above, the photosensitive resin composition of the invention comprises (A) a carboxyl group-containing binder polymer, (B) a photopolymerizing compound, (C) a photopolymerization initiator and (D) a dicyandiamide and/or its derivative (hereinafter referred to as “dicyandiamide”), wherein the (B) photopolymerizing compound contains (B1) a compound with a weight-average molecular weight of 3500-100000 and with a urethane bond and an ethylenic unsaturated group in the molecule (hereinafter referred to as “compound (B1)”).

The present inventors have discovered that by using compound (B1) mentioned above as the (B) photopolymerizing compound in the photosensitive resin composition, it is possible to impart excellent flexibility to the photocured photosensitive resin composition. The main reason for the excellent flexibility of the photocured composition with addition of compound (B1) is thought to be that the urethane bond of compound (B1) enhances the plasticity of the photocured composition. In addition, it is believed that the toughness of the photocured composition is enhanced by interaction between hydrogens of the other components and the nitrogen atom of the urethane bond.

The photosensitive resin composition of the invention exhibits an effect whereby excellent flexibility and a high level of both chemical resistance and plating resistance are obtained when the photosensitive resin composition is photocured. Presumably this results because simultaneous addition of compound (B1) and the dicyandiamide increases interaction with the surface of the metal sections such as the copper foil formed on the board, and enhances the adhesiveness between the metal sections and the photocured composition.

The weight-average molecular weight of compound (B1) is in the range of 3500-100000. Compound (B1) having a weight-average molecular weight within this range can produce a higher level of elongation, strength and plating resistance of the photocured composition as well as higher compatibility with component (A), than the same outside of the range.

From the viewpoint of even more effectively and reliably achieving the object of the invention, the (A) carboxyl group-containing binder polymer is preferably one containing an acrylic resin.

According to the invention, compound (B1) may be obtained by reacting a compound containing a hydroxyl and an ethylenic unsaturated group with a urethane compound having a urethane bond derived from reaction between the terminal hydroxyl group of a polycarbonate compound and/or polyester compound and the isocyanate group of a diisocyanate compound, and having isocyanate groups at multiple ends. Using compound (B1) obtained in this manner can more effectively and reliably achieve the object of the invention.

The photosensitive element of the invention is provided with a photosensitive layer comprising a support and the aforementioned photosensitive resin composition of the invention formed on the support. The photosensitive element is in the form of a film, and the photosensitive layer of the photosensitive element comprises a photosensitive resin composition according to the invention. It is therefore possible to achieve high levels of flexibility, chemical resistance and plating resistance even after curing of the photosensitive layer. Because of these properties, the photocured photosensitive layer is suitable for formation of permanent masks, such as cover lays and cover coats for protection of FPC conductors.

### EFFECT OF THE INVENTION

According to the invention it is possible to provide a photosensitive resin composition that can achieve high levels of flexibility, chemical resistance and plating resistance after photocuring, and a photosensitive element employing the composition.

### BRIEF DESCRIPTION OF THE DRAWINGS

FIG. 1 is a schematic view of the cross-sectional structure of a photosensitive element according to an embodiment of the invention.

### EXPLANATIONS OF NUMERALS

1: Photosensitive element, 10: support, 20: photosensitive layer, 30: protective film.

### BEST MODES FOR CARRYING OUT THE INVENTION

Embodiments of the invention will now be explained in detail, with reference to the accompanying drawings. Throughout the explanation of the drawings, corresponding elements will be referred to by like reference numerals and will be explained only once. For convenience of illustration, the dimensional proportions in the drawings may not match those explained in the text.

The photosensitive resin composition of the invention comprises

(A) a carboxyl group-containing binder polymer, (B) a photopolymerizing compound, (C) a photopolymerization initiator and (D) a dicyandiamide. Components (A)-(D) will now be explained in detail.

The carboxyl group-containing binder polymer used as component (A) may be produced by radical polymerization of, for example, a carboxyl group-containing polymerizable monomer and another polymerizable monomer. The carboxyl group-containing binder polymer provides solubility in aqueous alkali solutions. As examples of carboxyl group-containing polymerizable monomers there may be mentioned (meth)acrylic acid-based monomers such as (meth)acrylic acid, α-bromo(meth)acrylic acid, α-chlor(meth)acrylic acid, β-furyl(meth)acrylic acid and β-styryl(meth)acrylic acid, as well as maleic acid, fumaric acid, cinnamic acid, α-cyanocinnamic acid, itaconic acid, crotonic acid, propiolic acid and the like. (Meth)acrylic acid and/or maleic acid are preferred among these from the standpoint of developing properties. Any of these may be used alone or in combinations of two or more.

As examples of the other polymerizable monomer used for radical polymerization with the carboxyl group-containing polymerizable monomer, there may be mentioned styrene; polymerizable styrene derivatives substituted at the α-position or aromatic ring, such as vinyltoluene or α-methylstyrene; acrylamides such as diacetoneacrylamide; acrylonitrile; methacrylonitrile; N-vinylpyrrolidone; vinyl alcohol esters such as vinyl-n-butyl ether; acrylic acid esters such as (meth)acrylic acid alkyl esters, tetrahydrofurfuryl(meth)acrylate ester, dimethylaminoethyl (meth)acrylate ester, diethylaminoethyl(meth)acrylate ester, glycidyl (meth)acrylate ester, 2,2,2-trifluoroethyl(meth)acrylate and 2,2,3,3-tetrafluoropropyl(meth)acrylate; maleic acid monoesters such as maleic acid anhydride, monomethyl malate, monoethyl malate and monoisopropyl malate; and styrene/maleic acid copolymer half-esters. Any of these may be used alone or in combinations of two or more.

Component (A) preferably contains an acrylic resin. Including an acrylic resin in component (A) provides the advantage of producing a photosensitive resin composition that has excellent stability and is easily formed into a film. The term “(meth)acrylic acid” as used with regard to the invention means acrylic acid or its corresponding methacrylic acid, (meth)acrylate means acrylate or its corresponding methacrylate, and (meth)acryloyl group means acryloyl or its corresponding methacryloyl group.

As examples of the aforementioned (meth)acrylic acid alkyl esters there may be mentioned compounds represented by the following general formula (I).

CH₂═C(R¹)—COOR² (I)

In general formula (I), R¹ represents hydrogen or a methyl group. R² represents a C1-12 alkyl group having hydrogens optionally substituted with hydroxyl, epoxy, halogen atoms or the like.

The weight-average molecular weight of the carboxyl group-containing binder polymer used as component (A) is preferably 20000-300000, more preferably 30000-150000 and even more preferably 40000-100000. A weight-average molecular weight of less than 20000 will tend to result in lower film formability, while at greater than 300000 the developing property will tend to be inferior.

The acid value of component (A) is preferably 30-250 mgKOH/g and more preferably 50-200 mgKOH/g. If the acid value is less than 30 mgKOH/g the developing time will tend to be longer, and if it is greater than 250 mgKOH/g the developing solution resistance of the photocured resist will tend to be reduced.

Component (B) will be explained next. Component (B) according to the invention contains compound (B1). Compound (B1) may be obtained by condensation reaction of a compound containing hydroxyl and ethylenic unsaturated groups, with a urethane compound having a urethane bond derived from reaction between the terminal hydroxyl group of a polycarbonate compound and/or polyester compound and the isocyanate group of a diisocyanate compound, and having isocyanate groups at multiple ends.

The urethane compound used for synthesis of compound (B1) may be obtained by reacting a polycarbonate compound and/or polyester compound having hydroxyl groups at both ends (the polycarbonate compound and polyester compound may hereinafter be referred to as “(1) polycarbonate compound” and “(2) polyester compound”, respectively) with a diisocyanate compound (hereinafter also referred to as “(3) diisocyanate compound”). From the viewpoint of obtaining a satisfactory appearance of the photocured composition, it is especially preferred to use a urethane compound obtained by reacting the (1) polycarbonate compound and (3) diisocyanate.

The (1) polycarbonate compound has a structure wherein the alkylene groups are arranged on the main chain via carbonate bonds, and it may be obtained by a known process. For example, a diol compound and a phosgene are reacted to obtain a polycarbonate compound by the phosgene method. As examples of diol compounds there may be mentioned diethylene glycol, triethylene glycol, tetraethylene glycol, tripropylene glycol, polypropylene glycol, ethylene glycol, 1,2-propanediol, 1,3-butanediol, 1,4-butanediol, 2-methyl-1,3-butanediol, neopentyl glycol, 2-methylpentanediol, 3-methylpentanediol, 2,2,4-trimethyl-1,6-hexanediol, 3,3,5-trimethyl-1,6-hexanediol, 2,3,5-trimethyl-pentanediol, 1,6-hexanediol, 1,5-pentanediol and the like, any of which may be used alone or in combinations of two or more. Polyol compounds such as trimethylolpropane, trimethylolethane, hexanetriol, heptanetriol and pentaerythritol may also be included.

Preferred among the aforementioned polycarbonate compounds are those that include in the molecule the hexamethylene carbonate structure represented by the following general formula (II), derived from 1,6-hexanediol, and the pentamethylene carbonate structure represented by the following general formula (III), derived from 1,5-pentanediol.

—(CH₂)₆—O—CO—O— (II)

—(CH₂)₅—O—CO—O— (III)

The molar ratio of hexamethylene carbonate and pentamethylene carbonate in the polycarbonate compound is preferably hexamethylene carbonate/pentamethylene carbonate=1/9-9/1. If the ratio is outside of this range, the elongation and strength of the photocured composition will tend to be reduced.

The (2) polyester compound may be obtained by a known process based on polycondensation of a polybasic acid and a polyhydric alcohol. As examples of polybasic acids there may be mentioned aromatic and aliphatic dicarboxylic acids such as terephthalic acid, isophthalic acid, adipic acid and sebacic acid. As examples of polyhydric alcohols there may be mentioned glycols such as ethylene glycol, propylene glycol, 1,4-butanediol, hexanediol, neopentyl glycol, diethylene glycol and triethylene glycol.

The weight-average molecular weight of the polycarbonate compound and polyester compound (for example, measured by GPC and in terms of polystyrene) is preferably 600-1000. If the weight-average molecular weight is outside of this range, the elongation and strength of the photocured composition will tend to be reduced.

As examples for the (3) diisocyanate compound there may be mentioned aliphatic diisocyanate compounds with divalent aliphatic groups such as alkylene groups, alicyclic diisocyanate compounds with divalent alicyclic groups such as cycloalkylene groups, and aromatic diisocyanate compounds, as well as isocyanurate-modified, carbodiimide-modified and biuret-modified forms of the above.

As examples of aliphatic diisocyanate compounds there may be mentioned hexamethylene diisocyanate, trimethylhexamethylene diisocyanate and the like. As examples of alicyclic diisocyanate compounds there may be mentioned isophorone diisocyanate, methylenebis(cyclohexyl)diisocyanate and 1,3- or 1,4-bis(isocyanatomethyl)cyclohexane. As aromatic diisocyanate compounds there may be mentioned dimeric polymers of 2,4-toluene diisocyanate, 2,6-toluene diisocyanate, 2,4-toluene diisocyanate or 2,6-toluene diisocyanate, and (o, p or m)-xylene diisocyanate, diphenylmethane diisocyanate, 1,5-naphthalene diisocyanate and the like. These may be used alone or in combinations of two or more. Isocyanate compounds with two or more isocyanate groups such as triphenylmethane triisocyanate and tris(isocyanatophenyl) thiophosphate may also be included. Preferred among the above are alicyclic diisocyanate compounds and especially isophorone diisocyanate, from the standpoint of achieving a higher level of flexibility and toughness for the photocured composition.

The urethane compound with isocyanate groups at multiple ends (hereinafter referred to as “(4) urethane compound”) may be obtained by reacting the (1) polycarbonate compound and/or (2) polyester compound with the (3) diisocyanate compound. The (4) urethane compound preferably has isocyanate groups at both ends. In this case, the content of the (3) diisocyanate compound in the reaction is preferably 1.01-2.0 mol and more preferably 1.1-2.0 with respect to 1 mol as the total of the (1) polycarbonate compound and (2) polyester compound. If the content of the (3) diisocyanate compound is less than 1.01 mol or greater than 2.0 mol, it may not be possible to stably obtain a urethane compound having isocyanate groups at both ends. Dibutyltin dilaurate is preferably added as a catalyst during the reaction for synthesis of the (4) urethane compound. The reaction temperature is preferably 60-120° C. The reaction will tend to proceed insufficiently at below 60° C., while rapid heat generation will tend to increase the hazard level with operation at above 120° C.

Examples of compounds having hydroxyl and ethylenic unsaturated groups in the molecule (hereinafter also referred to as “(5) hydroxyl group-containing ethylenic unsaturated compound”), which may be used for reaction with the urethane compound to obtain compound (B1), include compounds with hydroxyl and (meth)acryloyl groups in the molecule. As examples of such compounds there may be mentioned hydroxy(meth)acrylates, their caprolactone adducts and alkylene oxide adducts, ester compounds of polyhydric alcohols such as glycerin with (meth)acrylic acid, and glycidyl(meth)allylate acrylic acid adducts.

As examples of hydroxy(meth)acrylates there may be mentioned 2-hydroxyethyl(meth)acrylate, hydroxypropyl(meth)acrylate and hydroxybutyl(meth)acrylate. As examples of caprolactone adducts there may be mentioned hydroxyethyl(meth)acrylate-caprolactone adduct, hydroxypropyl(meth)acrylate-caprolactone adduct and hydroxybutyl(meth)acrylate-caprolactone adduct, and as examples of alkylene oxide adducts there may be mentioned hydroxyethyl (meth)acrylate-alkylene oxide adduct, hydroxypropyl (meth)acrylate-propylene oxide adduct and hydroxyethyl (meth)acrylate-butylene oxide adduct. As examples of ester compounds there may be mentioned glycerin mono(meth)acrylate, glycerin di(meth)acrylate, pentaerythritol tri(meth)acrylate, dipentaerytritol tri(meth)acrylate, trimethylolpropane mono(meth)acrylate, ditrimethylolpropane tri(meth)acrylate, di(meth)acrylates of trimethylolpropane ethylene oxide adducts and di(meth)acrylates of trimethylolpropane propylene oxide adducts. These may be used alone or in combinations of two or more.

Compound (B1) may be obtained by addition reaction of the (5) hydroxyl group-containing ethylenic unsaturated compound with the (4) urethane compound. For the addition reaction, the content of the (5) hydroxyl group-containing ethylenic unsaturated compound is preferably 2.0-2.4 mol to 1 mol of the (4) urethane compound. The photopolymerizing property will tend to be inadequate if the content of the (5) hydroxyl group-containing ethylenic unsaturated compound is less than 2.0 mol, while the elongation and strength of the photocured composition will tend to be lower if it exceeds 2.4 mol. The addition reaction is preferably conducted in the presence of p-methoxyphenol or di-t-butyl-hydroxy-toluene, for example, and dibutyltin dilaurate is also preferably added as a catalyst. The reaction temperature is preferably 60-90° C. The reaction will tend to proceed insufficiently at below 60° C., while rapid heat generation will tend to result in gelling at above 90° C. The end point of the reaction is the point at which disappearance of isocyanate groups is confirmed based on the infrared absorption spectrum, for example.

From the viewpoint of improving the developing property, compound (B1) is preferably obtained by copolymerization of carboxyl group-containing components.

The weight-average molecular weight of compound (B1) is 3500-100000, preferably 3500-50000 and more preferably 3500-20000. A weight-average molecular weight of less than 3500 will result in insufficient plating resistance of the photocured composition, as well as reduced flexibility due to insufficient elongation and strength of the photocured composition. On the other hand, a weight-average molecular weight of greater than 100000 will lower compatibility with the aforementioned component (A).

Compound (B1) may be synthesized by ordinary methods or obtained as a commercial product. As examples of commercially available products for compound (B1) there may be mentioned UF-8003 M, UF-TCB-50 and UF-TC4-55 (trade names of Kyoeisha Chemical Co., Ltd.) and HITALLOID 9082-95 (trade name of Hitachi Chemical Co., Ltd.).

Component (B) may also contain other photopolymerizing compounds in addition to compound (B1). As examples of other photopolymerizing compounds there may be mentioned compounds obtained by reacting α,β-unsaturated carboxylic acids with polyhydric alcohols, compounds obtained by reacting α,β-unsaturated carboxylic acids with 2,2-bis(4-(di(meth)acryloxypolyethoxy)phenyl)propane or glycidyl group-containing compounds, as well as urethane monomers, (meth)acrylic acid alkyl esters, nonylphenyldioxylene (meth)acrylate, γ-chloro-β-hydroxypropyl-β′-(meth)acryloyloxyethyl-o-phthalate, β-hydroxyethyl-β′-(meth)acryloyloxyethyl-o-phthalate and β-hydroxypropyl-β′-(meth)acryloyloxyethyl-o-phthalate. (Meth)acrylic acids may be mentioned as examples of α,β-unsaturated carboxylic acids. These photopolymerizing compounds may be used alone or in combinations of two or more.

The other photopolymerizing compounds may also be synthesized by ordinary methods or obtained as commercial products. As examples of commercially available products for other photopolymerizing compounds there may be mentioned the 2,2′-bis((4-methacryloxypentaethoxy)phenyl)propane product BPE-500 (trade name of Shin-Nakamura Chemical Co., Ltd.), the trimethylolpropane triacrylate product A-TNPT (trade name of Shin-Nakamura Chemical Co., Ltd.) and the 2,2,4-trimethylhexamethylene-1,6-diisocyanato/2-hydroxyethyl acrylate=1/2 (molar ratio) adduct TMCH (trade name of Hitachi Chemical Co., Ltd.).

The (C) photopolymerization initiator will now be explained. The photopolymerization initiator generates free radicals by activating light rays. As examples for component (C) there may be mentioned aromatic ketones, quinones, benzoinether compounds, benzyl derivatives, 2,4,5-triarylimidazole dimers, acridine derivatives, N-phenylglycine, N-phenylglycine derivatives, coumarin-based compounds and the like.

As aromatic ketones there may be mentioned benzophenone, N,N′-tetramethyl-4,4′-diaminobenzophenone (Michler's ketone), N,N′-tetraethyl-4,4′-diaminobenzophenone, 4-methoxy-4′-dimethylaminobenzophenone, 2-benzyl-2-dimethylamino-1-(4-morpholinophenyl)-butan-1-one and 2-methyl-1-[4-(methylthio)phenyl]-2-morpholino-propan-1-one. As quinones there may be mentioned 2-ethylanthraquinone, phenanthrenequinone, 2-tert-butylanthraquinone, octamethylanthraquinone, 1,2-benzanthraquinone, 2,3-benzanthraquinone, 2-phenylanthraquinone, 2,3-diphenylanthraquinone, 1-chloroanthraquinone, 2-methylanthraquinone, 1,4-naphthoquinone, 9,10-phenanthraquinone, 2-methyl-1,4-naphthoquinone and 2,3-dimethylanthraquinone. As benzoinether compounds there may be mentioned benzoinmethyl ether, benzomethyl ether and benzoinphenyl ether. As benzyl derivatives there may be mentioned benzoin, benzoin compounds such as methylbenzoin and ethylbenzoin, and benzyldimethylketal. As 2,4,5-triarylimidazole dimers there may be mentioned 2-(o-chlorophenyl)-4,5-diphenylimidazole dimers such as 2-(2-chlorophenyl)-1-[2-(2-chlorophenyl)-4,5-diphenyl-1,3-diazole-2-yl]-4,5-diphenylimidazole, and 2-(o-chlorophenyl)-4,5-di(methoxyphenyl)imidazole dimer, 2-(o-fluorophenyl)-4,5-diphenylimidazole dimer, 2-(o-methoxyphenyl)-4,5-diphenylimidazole dimer, 2-(p-methoxyphenyl)-4,5-diphenylimidazole dimer and the like. As acridine derivatives there may be mentioned 9-phenylacridine and 1,7-bis(9,9′-acridinyl)heptane.

The substituents on the two 2,4,5-triarylimidazole groups of a 2,4,5-triarylimidazole dimer may be the same or different. A combination of a thioxanthone-based compound and tertiary amine compound may also be used, such as a combination of diethylthioxanthone and dimethylaminobenzoic acid.

Component (C) may be synthesized by ordinary methods or obtained as a commercial product. As examples of commercially available products for component (C) there may be mentioned IRGACURE-369 (trade name of Ciba Specialty Chemicals, Inc.) and IRGACURE-907 trade name of Ciba Specialty Chemicals, Inc.).

Any of the aforementioned photopolymerization initiators may be used alone or in combinations of two or more.

As examples of dicyandiamides for component (D) there may be mentioned dicyandiamide, acryloyldicyandiamide, methacryloyldicyandiamide and their organic acid salts, any of which may be used alone or in combinations of two or more. Dicyandiamide is preferred among these from the standpoint of achieving higher levels of chemical resistance and plating resistance. The main reason for the higher level of these properties is believed to be that the strong interaction between the surface of the surface metal portions formed on the board and the guanidine skeleton of the dicyandiamide improves adhesiveness between the metal portions and the photocured composition. The dicyandiamide may be obtained by reaction between a cyanamide and a carbodiimide.

Component (D) may be synthesized by ordinary methods or obtained as a commercial product. Dicyandiamide (DICY) by Japan Epoxy Resins Co., Ltd. may be mentioned as an example of a commercially available product for component (D).

The photosensitive resin composition of the invention comprises component (A), component (B), component (C) and component (D) and can be developed using an aqueous alkali solution. Development with an aqueous alkali solution is accomplished by adjusting the parameters of the photosensitive resin composition. For example, development with an aqueous alkali solution may be accomplished by adjusting the acid value of component (A).

The content of component (A) is preferably 30-80 parts by weight and more preferably 40-70 parts by weight with respect to 100 parts by weight as the total of component (A) and component (B). If the content is less than 30 parts by weight the photocured composition may be too fragile, tending to result in inferior coatability when used as a photosensitive element, while if it is greater than 80 parts by weight the photosensitivity will tend to be insufficient.

The content of component (B) is preferably 20-60 parts by weight and more preferably 30-60 parts by weight with respect to 100 parts by weight as the total of component (A) and component (B). If the content is less than 20 parts by weight the photosensitivity will tend to be insufficient, and if it is greater than 60 parts by weight the photocured product will tend to be fragile. The content of compound (B1) is preferably 40-100 parts by weight, more preferably 50-90 parts by weight and most preferably 60-80 parts by weight with respect to 100 parts by weight of component (B).

The content of component (C) is preferably 0.1-20 parts by weight and more preferably 0.2-10 parts by weight with respect to 100 parts by weight as the total of component (A) and component (B). If the content is less than 0.1 part by weight the photosensitivity will tend to be insufficient, and if it is greater than 20 parts by weight the absorption on the surface of the composition during exposure will increase, tending to result in insufficient interior photocuring. The content of component (D) is preferably 0.1-10 parts by weight, more preferably 0.3-2.0 parts by weight and even more preferably 0.5-1.5 part by weight with respect to 100 parts by weight as the total of component (A) and component (B). If the content is less than 0.1 part by weight the chemical resistance and plating resistance will tend to be reduced, while development residue will tend to be produced if it is greater than 10 parts by weight.

The photosensitive resin composition of the invention may also contain added blocking agents (block curing agents), dyes, pigments, thermosetting components such as melamine resins, plasticizers, stabilizers and the like, as necessary.

The photosensitive resin composition of the invention may be dissolved in a solvent, for example, an alcohol-based solvent such as methanol or ethanol, a ketone-based solvent such as acetone, methyl ethyl ketone or methyl isobutyl ketone, an ether-based solvent such as methylcellosolve or ethylcellosolve, a chlorinated hydrocarbon-based solvent such as dichloromethane or chloroform, or toluene, N,N-dimethylformamide or the like, or a mixture of the above as necessary, to form a solution with a solid content of about 30-60 wt %.

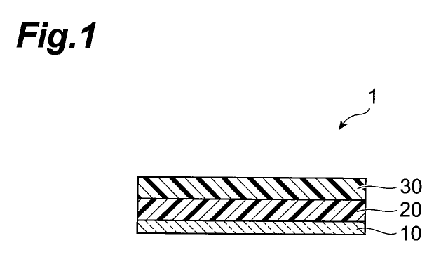

FIG. 1 is a schematic cross-sectional view showing a preferred embodiment of a photosensitive element of the invention. The photosensitive element 1 shown in FIG. 1 has a construction with a support 10, a photosensitive layer 20 formed on the support 10, and a protective film 30 formed on the photosensitive layer 20. The photosensitive layer 20 is a layer composed of a photosensitive resin composition of the invention as described above.

The photosensitive layer 20 is preferably formed by dissolving the photosensitive resin composition of the invention in the solvent or mixed solvent to make a solution with a solid content of about 30-60 wt % and then coating the solution onto the support 10.

The thickness of the photosensitive layer 20 will differ depending on the purpose, but the post-drying thickness is preferably 10-100 μm and more preferably 20-60 μm after removal of the solvent by heating and/or hot air blowing. A thickness of less than 10 μm will tend to hamper industrial coating, while a thickness of greater than 100 μm will tend to reduce the flexibility of the photocured composition.

As examples for the support 10 of the photosensitive element 1 there may be mentioned polymer films such as polyethylene terephthalate, polypropylene, polyethylene, polyester and the like. Polyethylene terephthalate is preferred among the above.

The thickness of the support 10 is preferably 5-100 μm and more preferably 10-30 μm. A thickness of less than 5 μm will tend to reduce the coverability, while a thickness of greater than 100 μm will tend to lower the resolution.

The thickness of the protective film 30 of the photosensitive element 1 is preferably 5-30 μm, more preferably 10-28 μm and even more preferably 15-25 μm. If the thickness is less than 5 μm the protective film 30 will tend to tear during lamination, while if it is greater than 30 μm the cost of the film will be tend to be higher.

The photosensitive element 1 obtained in the manner described above may be stored as is in the form of a flat sheet, or as a roll wound up on a winding core with a cylindrical or other shape. The photosensitive element 1 does not necessarily require the protective film 30, and it may have a two-layer structure with the support 10 and photosensitive layer 20.

Since the support 10 and protective film 30 must be subsequently removable from the photosensitive layer 20, they must not be surface treated in a manner that would prevent their removal. There are no restrictions on treatment other than surface treatment, and for example, the support 10 and protective film 30 may be subjected to antistatic treatment if necessary.

The photosensitive element 1 may be suitably used for formation of a resist pattern on a board such as a circuit-forming board. In this case, the resist pattern is formed by a process comprising, for example, a removal step in which the protective film 30 is removed from the photosensitive element 1, a lamination step in which the photosensitive element 1 is laminated on the circuit-forming board in such a manner that the photosensitive layer 20 is adjacent to the circuit-forming board, an exposure step in which prescribed sections of the photosensitive layer 20 are exposed to active light rays to form photocured sections on the photosensitive layer 20, and a developing step in which the sections other than the photocured sections on the photosensitive layer 20 are removed.

The circuit-forming board mentioned above is a board comprising an insulating layer and an electric conductor layer (made of copper, a copper-based alloy, nickel, chromium, iron or an iron-based alloy such as steel, and preferably copper, a copper-based alloy or an iron-based alloy) formed on the insulating layer.

In the lamination step, lamination is performed by a method involving, for example, contact bonding of the photosensitive layer 20 onto the circuit-forming board while heating. There are no particular restrictions on the atmosphere for lamination, but from the viewpoint of adhesiveness and follow-up property the lamination is preferably performed under reduced pressure. The laminated surface will normally be the electric conductor layer side of the circuit-forming board, but it may also be a side other than the electric conductor layer. The heating temperature for the photosensitive layer 20 is preferably 90-130° C., the contact bonding pressure is preferably 0.2-1.0 MPa, and the ambient air pressure is preferably no greater than 4000 Pa (30 mmHg). If the photosensitive layer 20 is heated at 90-130° C. as mentioned above it is not necessary to subject the circuit-forming board to pre-heating beforehand, but the circuit-forming board may also be preheated for further enhanced laminating properties.

In the exposure step, prescribed sections of the photosensitive layer 20 are exposed to active light rays to form photocured sections. The method of forming the photocured sections may be a method of irradiation with active light rays into an image form, through a negative or positive mask pattern known as artwork. If the support 10 is transparent, the active light rays may be irradiated through the support 10. If the support 10 is opaque, however, the active light rays are irradiated onto the photosensitive layer 20 after removing it.

The light source for the active light rays may be a publicly known light source such as, for example, a carbon arc lamp, mercury vapor arc lamp, ultra-high-pressure mercury lamp, high-pressure mercury lamp, xenon lamp or the like, which efficiently emits ultraviolet rays. There may also be used a lamp that efficiently emits visible light rays, such as a photographic flood lamp or sun lamp.

Following exposure, an aqueous alkali solution is used to remove the sections other than the photocured sections of the photosensitive layer 20, after removing the support 10 when the support 10 is present on the photosensitive layer 20 (developing step). This procedure results in formation of a resist pattern. An aqueous alkali solution suitable for the photosensitive resin composition is used in the developing step, and development may be accomplished by a publicly known method such as spraying, reciprocal dipping, brushing, scrapping or the like. Using an aqueous alkali solution as the developing solution will be satisfactory in terms of safety, stability and manageability. The pH of the aqueous alkali solution is preferably 9-11. The developing temperature may be adjusted depending on the developing property of the photosensitive layer 20. The aqueous alkali solution may also contain added surfactants, antifoaming agents, and small amounts of organic solvents to accelerate development.

The resist pattern obtained by the method described above is preferably used to form a flexible resin layer on a film-like board, and more preferably it is used as a permanent mask formed on a film-like board. When used as the cover coat (permanent mask) for a FPC, for example, ultraviolet irradiation with a high-pressure mercury lamp or heating is preferably carried out after completion of the developing step, in order to improve the soldering heat resistance and chemical resistance of the resulting FPC cover coat. When ultraviolet rays are used for exposure, the exposure dose is adjusted to, for example, about 0.2-10 J/cm². When the resist pattern is heated, the heating is preferably carried out in a range of about 100-170° C. for about 15-90 minutes. Ultraviolet irradiation and heating may also be combined. In this case, the ultraviolet irradiation and heating may be carried out simultaneously or one after the other. When ultraviolet ray exposure and heating are carried out simultaneously, the heating is preferably at 60-150° C. from the viewpoint of more effectively imparting soldering heat resistance and chemical resistance.

### EXAMPLES

The present invention will now be explained by examples.

### Example 1

### Production of Photosensitive Elements

The following components were added to solutions containing the materials listed in Table 1 at prescribed weight ratios to obtain photosensitive layer-forming coating solutions (photosensitive resin composition solutions). As compound (B1) in component (B) there was added 65 parts by weight (solid content) of UF-8003 M (80% methyl ethyl ketone solution, trade name of Kyoeisha Chemical Co., Ltd.), as another photopolymerizing compound there was added 20 parts by weight of BPE-500 (trade name of Shin-Nakamura Chemical Co., Ltd.), and as component (D) there was added 1 part by weight of dicyandiamide (product of Japan Epoxy Resins Co., Ltd.), together with 3 parts by weight of N,N-dimethylformamide (solvent).

The solid content of UF-8003 M™ was composed of a photopolymerizing compound obtained by reacting 2 mol of 2-hydroxyethyl acrylate with a urethane compound having isocyanate groups at the ends, and the weight-average molecular weight was 3500. The urethane compound was obtained by addition polymerization of 3 mol of a polycarbonate compound containing hexamethylene carbonate/pentamethylene carbonate=5/5 (molar ratio) as a repeating unit and having hydroxyl groups at the ends (weight-average molecular weight: 790) and 4 mol of isophorone diisocyanate.

The weight-average molecular weights of the binder polymer as component (A) and of compound (B1) were determined by gel permeation chromatography (GPC) measurement, from a calibration curve using standard polystyrene. The GPC measurement conditions were as follows.

### Pump: Hitachi L-6000 (Hitachi, Ltd.).

Column: Gelpack GL-R420+Gelpack GL-R430+Gelpack GL-R440 (total: 3) (all trade names of Hitachi Chemical Co., Ltd.).

### Eluent: Tetrahydrofuran.

Measuring temperature: Room temperature
Flow rate: 2.05 mL/min

### Detector: Hitachi L-3300 RI (Hitachi, Ltd.).

The photosensitive layer-forming coating solution obtained in the manner described above was evenly applied onto a 25 μm-thick polyethylene terephthalate film and dried for 5 minutes with a circulating hot-air drier at 100° C. for removal of the solvent to form a photosensitive layer. The thickness of the photosensitive layer obtained after drying was 40 μm. A polyethylene film was laminated on the photosensitive layer as a protective film to obtain a photosensitive element.

As pretreatment for an FPC board (trade name: F30 VC125RC11, by Nikkan Industries Co., Ltd.) comprising a copper foil (film thickness: 35 μm) laminated on a polyimide substrate, the copper foil surface was polished with an abrasive brush, rinsed and then dried. The FPC board was mounted in a vacuum laminator (MVLP-500, product of Meiki Co., Ltd.), and the photosensitive element was laminated with the FPC board surface facing the photosensitive layer of the photosensitive element (lamination step). The protective film was released before laminating the photosensitive element on the surface of the FPC board.

The molding temperature in the vacuum laminator was 60° C., the molding pressure was 0.4 MPa (4 kgf/cm²), and the evacuating time and pressurizing time were both 20 seconds.

The laminate obtained from the lamination step was cooled at 23° C. and allowed to stand for at least an hour, after which an exposure apparatus (Model HMW-201B by Orc Manufacturing Co., Ltd.) was used for light exposure (ultraviolet intensity: 150 mJ/cm²). A Stouffer 21-step tablet was used for exposure of the laminate. After allowing the laminate to stand at ordinary temperature for 30 minutes, a 1% aqueous sodium carbonate solution was used for spray development at 30° C. for 50 seconds. This was followed by 50 minutes of heat treatment at 160° C. Also, an ultraviolet irradiation apparatus (product of Toshiba Corp., rated voltage: 200 V, rated consumption: 7.2 kW) was used for ultraviolet irradiation (ultraviolet intensity: 1 J/cm²), to form a cover lay (permanent resist pattern) as a negative film on the surface of the FPC board. Multiple FPC boards with surface cover lays were formed in the manner described above and subjected to the following evaluation test.

[Flexibility Evaluation]

The FPC board was subjected to a folding endurance test in the following manner to evaluate its flexibility. Specifically, the FPC board with the surface cover lay was immersed for 10 seconds in a solder bath at 260° C. for solder treatment, after which it was folded 180° by seam folding and the condition of cracking in the folded cover lay was visually examined. The evaluation was made as follows.

A: No cracking

### B: Cracking

[Chemical Resistance Evaluation]

The FPC board with surface cover lay was immersed for 30 minutes in a 2N aqueous hydrochloric acid solution at ordinary temperature, after which the condition of staining and bubbles at the open section of the permanent resist pattern was visually examined to evaluate the acid chemical resistance. In the same manner, the FPC board was also immersed in a 2N aqueous sodium hydroxide solution to evaluate the alkaline chemical resistance. The evaluation was made as follows.

A: No staining or bubbles
B: Staining or bubbles

[Plating Resistance Evaluation]

In order to evaluate the plating resistance of the cover lay, first electroless nickel/gold plating treatment was carried out in the following manner. A FPC board with surface cover lay was subjected to degreasing (5 min dipping), rinsing, soft etching (2 min dipping), rinsing, acid cleaning (3 min dipping), rinsing, predipping (90 sec dipping), electroless nickel plating (23 min), rinsing, electroless gold plating (15 min), rinsing and drying, in that order. The materials used for each step were the following.

Degreasing: 25 wt % aqueous solution of PC-455 (Meltex, Inc.)
Soft etching: 150 g/L aqueous solution of ammonium persulfate
Acid cleaning: 5 vol % aqueous solution of sulfuric acid
Electroless nickel plating: NIMDEN NPF-2 (trade name of Uyemura & Co., Ltd.)
Electroless gold plating: GOBRIGHT TIG-10 (trade name of Uyemura & Co., Ltd.)

After drying, cellophane adhesive tape was immediately attached to the cover lay section and then pulled off vertically (90° peel-off test), and any peeling of the cover lay was noted. The evaluation was made as follows.

A: No peeling
B: Slight peeling
C: Significant peeling

The section was also visually examined for any sinking of the gold plating. When sinking of the gold plating occurs, the plating-deposited gold can be seen under the transparent cover lay. The evaluation was made as follows.

A: No sinking
B: Slight sinking
C: Significant sinking

### Example 2

A photosensitive element was produced in the same manner as Example 1, except that 20 parts by weight of A-TMPT (trade name of Shin-Nakamura Chemical Co., Ltd.) was used instead of BPE-500™ as another component in component (B). This was used to form a cover lay, which was then subjected to the same evaluation tests as in Example 1.

### Example 3

A photosensitive element was produced in the same manner as Example 1, except that 20 parts by weight of TMCH (trade name of Hitachi Chemical Co., Ltd.) was used instead of BPE-500™ as another component in component (B). This was used to form a cover lay, which was then subjected to the same evaluation tests as in Example 1.

### Example 4

A photosensitive element was produced in the same manner as Example 1, except that 65 parts by weight (solid content) of UF-TCB-50 (trade name of Kyoeisha Chemical Co., Ltd., 60% methyl ethyl ketone solution) was used instead of UF-8003 M as compound (B1) in component (B). This was used to form a cover lay, which was then subjected to the same evaluation tests as in Example 1. UF-TCB-50™ is a photopolymerizing compound obtained by reacting a polyester compound with terminal hydroxyl groups, an organic isocyanate and 2-hydroxyethyl acrylate, and it has a weight-average molecular weight of 15000.

### Example 5

A photosensitive element was produced in the same manner as Example 1, except that 65 parts by weight (solid content) of HITALLOID 9082-95 (trade name of Hitachi Chemical Co., Ltd., 75% methyl ethyl ketone solution) was used instead of UF-8003 M as compound (B1) in component (B). This was used to form a cover lay, which was then subjected to the same evaluation tests as in Example 1. HITALLOID 9082-95™ is a photopolymerizing compound obtained by reacting a polycarbonate compound with terminal hydroxyl groups, an organic isocyanate and 2-hydroxyethyl acrylate, and it has a weight-average molecular weight of 4000.

### Example 6

A photosensitive element was produced in the same manner as Example 1, except that 65 parts by weight (solid content) of UF-TC4-55 (trade name of Kyoeisha Chemical Co., Ltd., 60% methyl ethyl ketone solution) was used instead of UF-8003 M as compound (B1) in component (B). This was used to form a cover lay, which was then subjected to the same evaluation tests as in Example 1. UF-TC4-55™ is a photopolymerizing compound obtained by reacting a polyester compound with terminal hydroxyl groups, an organic isocyanate and 2-hydroxyethyl acrylate, and it has a weight-average molecular weight of 20000.

### Comparative Example 1

A photosensitive element was produced in the same manner as Example 1, except that instead of adding compound (B1), there were used 30 parts by weight of BPE-500™ and 50 parts by weight of TMCH™ as component (B). This was used to form a cover lay, which was then subjected to the same evaluation tests as in Example 1.

### Comparative Example 2

A photosensitive element was produced in the same manner as Example 1, except that instead of adding compound (B1) to component (B) there were used 30 parts by weight of A-TMPT™ and 50 parts by weight of TMCH™. This was used to form a cover lay, which was then subjected to the same evaluation tests as in Example 1.

### Comparative Example 3-5

Photosensitive elements were produced in the same manner as Example 1, except that substitutes for component (D) were used in Comparative Examples 3-5, without addition of the dicyandiamide as component (D). This was used to form a cover lay, which was then subjected to the same evaluation tests as in Example 1. For Comparative Examples 3-5 there were used 1 part by weight of 5-amino-2-mercapto-1,3,4-thiadiazole, 1 part by weight of 2-mercaptobenzoimidazole and 1 part by weight of 2,5-carboxy-1,2,3-benzotriazole, respectively, in place of the 1 part by weight of dicyandiamide.

### Comparative Example 6

A photosensitive element was produced in the same manner as Example 1, except that 65 parts by weight of UA-21 (trade name of Shin-Nakamura Chemical Co., Ltd.) was used as a substitute for UF-8003 M as compound (B1) in component (B). This was used to form a cover lay, which was then subjected to the same evaluation tests as in Example 1. UA-21™ is a photopolymerizing compound with an isocyanuric ring, a urethane bond and an ethylenic unsaturated group, and it has an calculated average molecular weight of 1554 and a measured weight-average molecular weight of 3000.

The contents of component (B) and component (D) and of the compound (B1) and component (D) substitutes in the photosensitive resin compositions used in Examples 1-4 and Comparative Examples 1-6, and their results in evaluation testing, are shown in Table 2 and Table 3.

TABLE 1

| | Material | Content | |
|---|---|---|---|
| Component (A) | Methyl cellosolve/toluene (wt. ratio: 60/40) solution | 162.5 | pts. by wt. |
| | containing 40 wt % of a methacrylic acid/methyl | (65 | pts. by solid wt.) |
| | methacrylate/butyl acrylate (wt. ratio: 22/71/7, wt. average | | |
| | mol. wt.: 8000) copolymer in | | |
| Component (C) | IRGACURE 369 | 3.0 pts. by wt. | |
| | N,N′-Tetraethyl-4,4′-diaminobenzophenone | 0.1 | pts. by wt. |
| Components | Methyl ethyl ketone containing 75 wt % of a blocked | 20 | pts. by wt. |
| other than | isocyanate compound obtained by reacting isocyanate | (15 | pts. by solid wt.) |
| Components (A)-(D) | compound (formula (IV) below) and methyl ethyl ketone | | |
| | oxime (formula (V) below) as a blocking agent. | | |
| | Victoria Pure Blue | 0.02 | pts. by wt. |
| | Methyl ethyl ketone | 45 | pts. by wt. |
| | Acetone | 45 | pts. by wt. |

| | |
|---|---|
| | [Chemical Formula 1] |
| 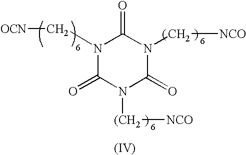 | |
| 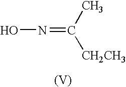 | |

TABLE 2

| | | | Example 1 | Example 2 | Example 3 | Example 4 | Example 5 | Example 6 |
|---|---|---|---|---|---|---|---|---|
| Component (B) | UF-8003M | | 65 | 65 | 65 | — | — | — |
| | (Compound (B1)) | | | | | | | |
| | UF-TCB-50 | | — | — | — | 65 | — | — |
| | (Compound (B1)) | | | | | | | |
| | HITALLOID | | — | — | — | — | 65 | — |
| | 9082-95 | | | | | | | |
| | (Compound (B1)) | | | | | | | |
| | UF-TC4-55 | | — | — | — | — | — | 65 |
| | (Compound (B1)) | | | | | | | |
| | BPE-500 | | 20 | — | — | 20 | 20 | 20 |
| | A-TMPT | | — | 20 | — | — | — | — |
| | TMCH | | — | — | 20 | — | — | — |
| Component (D) | Dicyandiamide | | 1 | 1 | 1 | 1 | 1 | 1 |
| Solvent | N,N-Dimethylformamide | | 3 | 3 | 3 | 3 | 3 | 3 |
| Wt. average mol. wt. of compound (B1) | | | 3500 | 3500 | 3500 | 15000 | 4000 | 20000 |
| Evaluation | Flexibility | | A | A | A | A | A | A |
| | Chemical | 2N | A | A | A | A | A | A |
| | resistance | Hydrochloric | | | | | | |
| | | acid | | | | | | |
| | | 2N | A | A | A | A | A | A |
| | | Sulfuric acid | | | | | | |
| | Plating | Peeling | A | A | A | A | A | A |
| | resistance | Sinking | A | A | A | A | A | A |

TABLE 3

| | | | Comp. Ex. 1 | Comp. Ex. 2 | Comp. Ex. 3 | Comp. Ex. 4 | Comp. Ex. 5 | Comp. Ex. 6 |
|---|---|---|---|---|---|---|---|---|
| Component (B) | UF-8003M | | — | — | 65 | 65 | 65 | — |
| | (Compound (B1)) | | | | | | | |
| | BPE-500 | | 30 | — | 20 | 20 | 20 | 20 |
| | A-TMPT | | — | 30 | — | — | — | — |
| | TMCH | | 50 | 50 | — | — | — | — |
| UA-21 (Substitute for compound (B1)) | | | — | — | — | — | — | 65 |
| Component (D) | Dicyandiamide | | 1 | 1 | — | — | — | 1 |
| Solvent | N,N-Dimethylformamide | | 3 | 3 | 3 | 3 | 3 | 3 |
| Substitute for | 5-Amino-2-mercapto- | | — | — | 1 | — | — | — |
| component (D) | 1,3,4-thiadiazole | | | | | | | |
| | 2-Mercaptobenzimidazole | | — | — | — | 1 | — | — |
| | 2,5-Carboxy-1,2,3- | | — | — | — | — | 1 | — |
| | benzotriazole | | | | | | | |
| Weight average molecular weight of compound | | | — | — | 3500 | 3500 | 3500 | 3000 |
| (B1) or substitute for compound (B1) | | | | | | | | [Calculated: 1554] |
| Evaluation | Flexibility | | B | B | A | A | A | B |
| | Chemical | 2N | A | A | B | B | B | A |
| | resistance | Hydrochloric | | | | | | |
| | | acid | | | | | | |
| | | 2N | A | A | B | B | B | A |
| | | Sulfuric acid | | | | | | |
| | Plating | Peeling | B | B | C | C | C | A |
| | resistance | Sinking | B | B | C | C | C | B |

As clearly seen in Table 2 and Table 3, the present invention allows formation of cover lays with excellent flexibility, chemical resistance and plating resistance. Thus, photocured photosensitive resin compositions according to the invention are suitable for cover lays and cover coats for flexible FPCs.

### INDUSTRIAL APPLICABILITY

According to the invention it is possible to provide a photosensitive resin composition that can achieve high levels of flexibility, chemical resistance and plating resistance after photocuring, and a photosensitive element employing the composition.

1. A photosensitive resin composition comprising:
(A) a carboxyl group-containing binder polymer;
(B) a photopolymerizing compound;
(C) a photopolymerization initiator; and
(D) a dicyandiamide, or a derivative of the dicyandiamide, or the dicyandiamide and the derivative of the dicyandiamide,
wherein the (B) photopolymerizing compound contains (B1), a compound with a weight-average molecular weight of 3500-100000 and with a urethane bond and an ethylenic unsaturated group in the molecule.

2. A photosensitive resin composition according to claim 1, wherein the (A) carboxyl group-containing binder polymer contains an acrylic resin.

3. A photosensitive resin composition according to claim 1, wherein the (B1) compound with the weight-average molecular weight of 3500-100000 and with the urethane bond and the ethylenic unsaturated group in the molecule is obtained by reacting
a urethane compound having a urethane bond derived from reaction between the terminal hydroxyl group of a polycarbonate compound, or the terminal hydroxyl group of a polyester compound, or the terminal hydroxyl group of the polycarbonate compound and the terminal hydroxyl group of the polyester compound, and the isocyanate group of a diisocyanate compound, and having isocyanate groups at multiple ends, with
a compound containing hydroxyl and ethylenic unsaturated groups.

4. A photosensitive element comprising:
a support; and
a photosensitive layer comprising the photosensitive resin composition according to claim 1 formed on the support.
